(19) United States
(12) Patent Application Publication
(10) Pub. No.: US 2026/0070407 A1
(43) Pub. Date: Mar. 12, 2026

(54) Heat Dissipation System for a Motor Vehicle, and Method

(71) Applicant: Bayerische Motoren Werke Aktiengesellschaft, Muenchen (DE)

(72) Inventors: Felix MUELLER-BERNER, Wielenbach (DE); Lukas RABE, Landshut (DE); Georg RAUCH, Wertingen (DE)

(21) Appl. No.: 19/321,382

(22) Filed: Sep. 8, 2025

(30) Foreign Application Priority Data
Sep. 9, 2024 (DE) 10 2024 125 753.9

(51) Int. Cl. B60K 11/06; B60K 11/08

(52) U.S. Cl. CPC B60K 11/06; B60K 11/08

(57) ABSTRACT

A heat dissipation system for a component of a motor vehicle arranged in a space by way of an air flow from an environment of the motor vehicle, with at least one air inlet device for introducing the air flow from the environment into the space and with at least one air discharge device for discharging the air flow from the space into the environment. The space is delimited downward in the vehicle vertical direction by an undertray of the motor vehicle and by respective side walls of the space. At least one discharge opening is arranged on at least one side wall delimiting the space, through which discharge opening the air flow can be discharged from the space into the environment.

### CROSS REFERENCE TO RELATED APPLICATION

This application claims priority under 35 U.S.C. § 119 from German Patent Application No. 10 2024 125 753.9, filed Sep. 9, 2024, the entire disclosure of which is herein expressly incorporated by reference.

### BACKGROUND AND SUMMARY

This disclosure relates to a heat dissipation system. The disclosure also relates to a method for operating such a heat dissipation system.

Heat dissipation systems for engine compartments are already known from the prior art, where hot air or an air flow from the engine compartment, in particular in the region of an exhaust gas system of an exhaust gas turbocharger (ATL) or hot end between the vehicle floor and undertray trim, is dissipated into the rear vehicle region. As a result, the components located behind the exhaust gas system in the rear of the vehicle are thermally loaded by the air heated by the exhaust gas system.

One object of the disclosure is to provide a heat dissipation system and a method by which components located in the rear of the vehicle are not affected by a heat exchange or heating of other components.

A first aspect of the disclosure relates to a heat dissipation system for a component arranged in a space, in particular an engine compartment, in particular an exhaust gas system of an exhaust gas turbocharger (ATL) or hot end of a motor vehicle, in particular a passenger car, by way of an air flow or an air stream from an environment of the motor vehicle. The exhaust gas system of the exhaust gas turbocharger (ATL) is arranged in the rear region of the motor vehicle, near the rear end or at the boundary to it. Here, the exhaust gas is conducted to this rear region through a pipe extending from the front region (in the vehicle longitudinal direction) of the vehicle to the rear. This arrangement makes it possible to efficiently transport the exhaust gases from the engine region to the rear, where they can then be processed or discharged accordingly. However, this exhaust gas system generates heat and leads to an increase in the ambient temperature in the region of the space where it is arranged. The heat generated by the exhaust gases can influence the surrounding components and therefore requires suitable measures for heat dissipation to avoid overheating and possible damage to nearby parts of the vehicle in the rear region. The heat dissipation system therefore comprises at least one air guiding device for introducing the air flow from the environment into the space and at least one air discharge device for discharging the air flow from the space into the environment. Here, furthermore, the space or the engine compartment is delimited in the vehicle vertical direction downwards by an undertray of the motor vehicle and in the vehicle transverse direction by respective side walls, arranged on the motor vehicle, for the engine compartment. In other words, the heat is dissipated by an air flow being introduced in a targeted manner by the air guiding device into the space, the cool ambient air flowing/sweeping over along the components (exhaust gas system) in the space, and finally being discharged again as a heated air flow by the air discharging device from the space into the environment. Here, however, the heated air flow would heat the components in the rear region at least partially by heat dissipation, which should be prevented.

In order to achieve the object of the disclosure, it is provided according to the disclosure that at least one discharge opening is arranged on at least one side wall delimiting the space, through which discharge opening the air flow can be discharged from the space into the environment. In contrast to the prior art, in which the air flow is discharged to the rear in the vehicle longitudinal direction, the air flow is discharged laterally to the environment in this disclosure. This is done by the discharge openings arranged on the lateral side walls of the space, which discharge openings are positioned, in particular, in the lower region of the side walls in the vehicle vertical direction.

The approach is not to allow the heated or hot air flow which is heated by the component or the exhaust gas system to flow through the entire engine compartment or space between the undertray and the body panel, but to already discharge it laterally beforehand. This prevents the heated air flow from reaching the rear region and causing an exchange of heat there with the components located in the rear region. Instead, the air flow is discharged at an early stage through the lateral discharge openings into the environment, which avoids overheating of the rear region components.

In other words, this design minimizes the heat transfer to the components arranged in the rear region, which avoids overheating thereof and potential damage thereto. In addition, the lateral discharge of the air flow improves the efficiency of the heat dissipation system by discharging heated air that is harmful to the components behind it at an early stage before the air flows through the entire space between the undertray and the body panel.

In an advantageous embodiment of the disclosure, it is provided that the at least one side wall is produced in some regions by a sill of the undertray, and the at least one discharge opening is arranged in the region of the sill. Accordingly, it is provided that the sill extending in an elongate manner in the vehicle longitudinal direction on the undertray is used to provide the discharge openings. This provides that the heated air flow is discharged particularly far down in the vehicle vertical direction, in particular in a lower corner region of the motor vehicle, as a result of which, for example, the discharge openings are also less visible or not at all visible. It is also provided that the discharge openings are designed in such a way that they provide the lowest possible air resistance by not being configured over a large area and being arranged on the sill.

In yet another advantageous embodiment of the disclosure, it is provided that the at least one side wall is produced in some regions by a body panel of the motor vehicle, and the at least one discharge opening is arranged in the region of the body panel. In contrast to the arrangement on the sill, it is now provided that the discharge openings are simply not located on the sill and therefore not on the undertray, but rather directly on the body panel. This leaves the undertray untouched and allows the respective discharge openings to be arranged on the body panel. As an alternative to this, it is also possible, however, to arrange discharge openings both on the body panel and on the sill, or in a transition region between the sill and the body panel.

In yet another advantageous embodiment of the disclosure, it is provided that the at least one discharge opening is arranged in front of a rear wheel arch in the vehicle longitudinal direction. This means that the discharge opening or the discharge openings is/are positioned as far forward as possible relative to the component, in particular in an embodiment of the component as an exhaust gas system. The arrangement of the discharge openings in the region in front of the rear wheel arch allows all components which are positioned to the rear in the vehicle longitudinal direction from this boundary to be no longer affected by the heated air flow. This prevents the exchange of heat and the heating of the components arranged in the rear region. Furthermore, this arrangement allows for the shortest and simplest possible line path through which the heated air flow can be discharged, in particular from the exhaust gas system to the environment of the motor vehicle.

In yet another advantageous embodiment of the disclosure, it is provided that the at least one discharge opening is delimited within the space laterally by at least one flow guiding element, in particular fins. These fins are accordingly designed and provided to intercept the outflowing air flow or the air flow which is directed in the direction of the discharge openings and to guide it in the direction of the discharge opening. As a result, for example, uncontrolled air flows or air vortices are transported or discharged in a controlled manner through the discharge openings, which enables an improved discharge of the heated air flow. These flow guide elements or these fins are accordingly designed in such a way that they reach particularly deep into the space and thus allow a discharge of the air flow which extends, in particular, from the component to the discharge opening. Such fins are accordingly arranged at the discharge openings, in particular on the sides of the discharge openings, and extend in the longitudinal extent direction, for example in the vehicle transverse direction in the direction of the interior or in the direction of the component and upward in the vehicle vertical direction. In an arrangement of a plurality of discharge openings next to each other, respective flow guide elements or fins would then be arranged between the respective discharge openings or at their boundaries, with the result that they can be used laterally for the two discharge openings.

In yet another advantageous embodiment of the disclosure, it is provided that at least one flow guiding system is arranged within the space. Now, not only the flow guiding elements or fins are to be used to guide the flow or the air flow in the direction of the discharge openings, but a further possibility is to be provided by the flow guiding system, firstly, to stop air flow in the direction of the rear region and also to deflect the flow accordingly in the direction of the discharge openings. In particular, such a flow guiding system comprises various air guiding elements within the space, which are designed to ensure that a flow, which is intercepted to the rear in the vehicle longitudinal direction, is discharged laterally in the direction of the discharge openings. Accordingly, for example, elements with high air resistance could be arranged in the space, with the result that the flow to the rear in the vehicle longitudinal direction is reduced to a particularly pronounced extent and is deflected in the direction of the discharge openings by the geometric design of these guide elements.

In yet another advantageous embodiment of the disclosure, it is provided that a discharge of the air flow via the at least one discharge opening can be controlled. It is accordingly provided that the discharge openings are not continuously in operation, for example can be closed, with the result that the air flow is then also carried out, for example, in the case of non-use of the heat dissipation system, in a conventional way to the rear in the vehicle longitudinal direction into the vehicle rear region, and is correspondingly discharged or output into an environment behind the motor vehicle in the vehicle longitudinal direction. However, should it be determined that the component becomes particularly hot or the heat state of the rear components is increased, it can be provided that this heat dissipation system and also the discharge of the air flow must be controlled, that is to say that the heat dissipation system is switched on and accordingly the air flow from the space is also discharged laterally.

In yet another advantageous embodiment of the disclosure, it is provided that the control of the discharge of the air flow can be carried out at least partially automatically in a manner dependent on detected vehicle parameters. Here, it is provided, in particular, for various devices or sensor devices also to be incorporated into the system; for example, temperature sensors could be arranged on the component in the interior. These temperature sensors thus measure the temperature of the component or the temperature of the space, and thus specify a vehicle parameter indicating that the heat dissipation system should be used. Furthermore, further temperature control sensors or further sensor devices might also be arranged in the rear region or on the respective components which are not to be heated, in order to carry out here a regulation of the heat dissipation system or a control and thus switching on of the heat dissipation system. Furthermore, it would also be possible, for example, to carry out the activation and/or deactivation of the heat dissipation system in the case of a speed measurement or in the case of other parameters of the motor vehicle or the vehicle and/or to establish a regulation of the heat dissipation system. In particular, for example, a space temperature should be maintained within the space, which is maintained accordingly by using the heat dissipation system.

In yet another advantageous embodiment of the disclosure, it is provided that a corresponding flap is arranged on the at least one discharge opening. Accordingly, it is provided that the discharge openings are closed, in particular in the case of non-use of a flap, with the result that it is not visible. Furthermore, sliding elements or valves can also be used to enable the closure of the discharge opening, with the result that, firstly, they are not visible and, secondly, the heat dissipation system is also not disrupted for a throughflow from front to rear in the vehicle longitudinal direction through the respective discharge openings.

Another aspect of the disclosure relates to a method for operating a heat dissipation system for a component of a motor vehicle arranged in a space, in which method an air flow is introduced from the environment into the space by way of at least one air guiding device, and the air flow is discharged from the space into the environment by way of an air discharge device. The space is delimited downward in the vehicle vertical direction by an undertray and laterally by side walls arranged in each case on the motor vehicle. In particular, it is provided that the air flow from the space into the environment is discharged via one or more discharge openings arranged on the side wall. In order to improve the efficiency, it is also provided that special fans are installed which conduct the air flow in a targeted manner in the direction of the discharge openings. These fans support the effective discharge of the heated air flow by actively conveying the air flow to the discharge opening, thus optimizing the heat dissipation.

In other words, the flow resistance is increased in the region between the undertray and the body by a partial blockage of the flow direction. As a result, the hot air from the environment of the hot end is directed in a targeted manner away from this region along the undertray in the direction of the heat-protected region of the front pipe. This targeted flow control prevents the hot air from directly entering the undertray region and along the body, thus enabling targeted heat dissipation. In addition, the convective dissipation of heat is supported by lateral openings to the vehicle outside. These lateral openings allow the heated air to be efficiently discharged into the environment outside the vehicle. In this way, the influence on the aerodynamics of the vehicle as well as the contamination load is minimized, since the heat dissipation is effectively regulated and disturbing effects on the vehicle surface are reduced.

Further features of the disclosure emerge from the claims, the figures and the description of the figures. The features and combinations of features mentioned above in the description, and the features and combinations of features mentioned below in the description of the figures and/or shown in the figures alone can be used not only in the respectively specified combination but also in other combinations or on their own.

### BRIEF DESCRIPTION OF THE DRAWING

FIG. 1 shows a perspective view of a structure of a motor vehicle, in which a heat dissipation system with lateral discharge openings is shown.

### DETAILED DESCRIPTION OF THE DRAWING

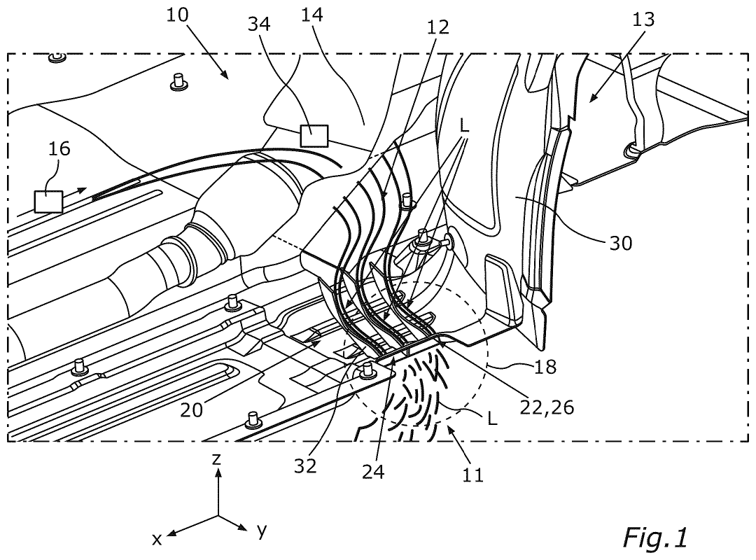

FIG. 1 shows a perspective view of a heat dissipation system 10 for a space 12, in particular an engine compartment, within which a component 14, in particular an exhaust turbocharger of the motor vehicle, is arranged. Here, the heat dissipation system 10 uses an air flow L from the environment of the motor vehicle, in order to cool this component 14 at least partially. Accordingly, it is provided to control the temperature of, in particular to cool, the component 14 by way of a sucked-in air flow L at least partially.

The heat dissipation system 10 comprises at least one air inlet device 16 for introducing the air flow L from the environment into the space 12, and at least one air discharge device 18 for discharging the air flow L from the space 12 into the environment. Here, the space 12 is delimited downward in the vehicle vertical direction Z by an undertray 20 of the motor vehicle and laterally by respective side walls 22 of the space 12. These side walls 22 can, for example, be formed from a body panel, as well as from a number of further components. A discharge opening 24 is accordingly arranged on at least one of the side walls 22 delimiting the space 12, through which discharge opening the air flow L can be discharged from the space 12 into the environment and thus not backward in the vehicle longitudinal direction as in the conventional case according to the prior art.

FIG. 1 is intended, in particular, to show the arrangement of the discharge openings 24, which is arranged on the side wall 22, in particular on a sill 26 of the undertray 20. The sill 26 is a part of the side wall 22 and is therefore arranged laterally relative to the space 12. Here, the discharge opening 24 is thus arranged on the sill 26 and allows the outflow of the air flow L into a lateral environment of the motor vehicle. As an alternative, the discharge opening 24 can also be arranged in the region of a body panel 28, which is not visible in FIG. 1; in addition, discharge openings 24 might also be arranged on the body panel 28 and on the sill 26 or in a transition region between the sill 26 and body panel 28, depending on the design of the heat dissipation system. Furthermore, the discharge opening 24 is arranged in front of a rear wheel arch 30 in the vehicle longitudinal direction X. The arrangement specifically shown here, which is shown in FIG. 1, allows a discharge of the air flow L from the component 14 on the shortest path into the environment, wherein, for this purpose, the discharge openings 24 are arranged laterally and thus the air flow L does not penetrate into a rear region 13 of the motor vehicle or flow through it.

In order to particularly favor the discharge of the air flow L, it is provided that the space 12 comprises flow guiding elements 32, in particular fins, and a flow guiding system 34. The flow guiding elements 32 are arranged laterally at the discharge openings 24 and enable a targeted discharge or outflow of the air flow L from the space through the discharge openings 24 and/or prevent air vortices. The flow guiding system 34, in contrast, comprises respective guiding elements 35 which comprise a high air resistance, and thus stop the interference of the air flow L to the rear in the vehicle longitudinal direction and, as a result of their geometric design, discharge in the direction of the discharge openings 24. Thus, the air flow L is deflected and discharged from the discharge openings 24 into the environment 11 of the motor vehicle.

Finally, it is possible that the discharge of the air flow L via the discharge opening 24 is controllable by way of, for example, the arrangement of an electronic computing device which is linked to all components. The control of the discharge of the air flow L can, for example, also take place at least partially automatically in a manner dependent on detected vehicle parameters 36. In particular, sensor devices can also be arranged, for example, on the component 14 or on other components in the rear region 13 of the motor vehicle, which carry out respective temperature adjustments or temperature measurements and accordingly switch on or off the heat dissipation system 10 or allow, or not, the discharge of the air flow L through the discharge openings 24. Furthermore, other vehicle parameters of the motor vehicle can also be recorded, such as the speed of the motor vehicle, in order to also control the heat dissipation system 10 here in a manner dependent on these parameters. Finally, a corresponding flap 38 is also arranged at the discharge opening 24, for example, which flap further regulates the discharge of the air flow L, for example increases or reduces the size of the discharge opening 24, depending on use, and/or also completely closes it if, for example, the heat dissipation system 10 does not have to be used. For example, at a standstill of the motor vehicle, the flaps 38 can close the discharge openings 24, with the result that firstly no dirt or exhaust gases enter the space and secondly for visual reasons, as a result of which the discharge openings become invisible.

In summary, the disclosure proposes the use of discharge fins for guiding and discharging hot air, which are attached in the immediate vicinity of the cover of the wheel arch 30.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

### LIST OF DESIGNATIONS

10 Heat dissipation system
11 Environment
12 Space
13 Rear compartment
14 Component
16 Air guiding device
18 Air discharge device
20 Undertray
22 Side walls
24 Discharge opening
26 Sill
28 Body panel
30 Wheel arch
32 Flow guiding element
34 Flow guiding system
36 Vehicle parameter
38 Flap
L Air flow
X Vehicle longitudinal direction
Z Vehicle vertical direction
Y Vehicle transverse direction

What is claimed is:

1. A heat dissipation system for a component of a motor vehicle arranged in a space by way of an air flow from an environment of the motor vehicle, the heat dissipation system comprising:
at least one air inlet device for introducing the air flow from the environment into the space,
at least one air discharge device for discharging the air flow from the space into the environment,
wherein the space is delimited downward in the vehicle vertical direction by an undertray of the motor vehicle and by respective side walls of the space, and
wherein at least one discharge opening is arranged on at least one side wall delimiting the space, through which discharge opening the air flow can be discharged from the space into the environment.

2. The heat dissipation system according to claim 1, wherein
the at least one side wall is produced in some regions by a sill of the undertray, and the at least one discharge opening is arranged in the region of the sill.

3. The heat dissipation system according to claim 1, wherein
the at least one side wall is produced in some regions by a body panel of the motor vehicle, and the at least one discharge opening is arranged in the region of the body panel.

4. The heat dissipation system according to claim 1, wherein
the at least one discharge opening is arranged in front of a rear wheel arch in the vehicle longitudinal direction.

5. The heat dissipation system according to claim 1, wherein
the at least one discharge opening is delimited within the space laterally by at least one flow guiding element.

6. The heat dissipation system according to claim 1, wherein
at least one flow guiding system is arranged within the space.

7. The heat dissipation system according to claim 1, wherein
a discharge of the air flow via the at least one discharge opening can be controlled.

8. The heat dissipation system according to claim 7, wherein
the control of the discharge of the air flow can be carried out at least partially automatically in a manner dependent on detected vehicle parameters.

9. The heat dissipation system according to claim 1, wherein
a flap is arranged on the at least one discharge opening.

10. A method for operating a heat dissipation system for a component of a motor vehicle arranged in a space by way of an air flow from an environment of the motor vehicle, the method comprising:
using at least one air inlet device to introduce the air flow from the environment into the space, and
using at least one air discharge device to discharge the air flow from the space into the environment,
wherein the space is delimited downward in the vehicle vertical direction by an undertray of the motor vehicle and by respective side walls of the space, and
wherein the air flow from the space is discharged into the environment via at least one discharge opening arranged on a side wall delimiting the space.
